(19) United States
(12) Patent Application Publication
(10) Pub. No.: US 2022/0087211 A1
(43) Pub. Date: Mar. 24, 2022

(54) PORTABLE LITTER BOX

(71) Applicants: Ian Berk, Astoria, NY (US); Emily Miethner, Astoria, NY (US)

(72) Inventors: Ian Berk, Astoria, NY (US); Emily Miethner, Astoria, NY (US)

(21) Appl. No.: 17/481,584

(22) Filed: Sep. 22, 2021

Related U.S. Application Data
(60) Provisional application No. 63/081,458, filed on Sep. 22, 2020.

(51) Int. Cl. A01K 1/01

(52) U.S. Cl. CPC A01K 1/0125; A01K 1/011

(57) ABSTRACT

A portable and foldable waste sanitation device for cats and other house pets to dispose of bodily waste, i.e. feces and urine that is easy to transport, clean, and odor proof by utilizing a zipper mechanism and a folding mechanism. The device includes four lined walls, a lined floor, and lined and zippered top with handles, and an extra zippered pocket on the top of the device for storage. The lining of the device prevents odor from escaping the device and lends to easy clean up. A strap with a fastening mechanism snap is secured to the side of the device to easily fold into a compact package for storage while traveling.

### CROSS-REFERENCE TO RELATED APPLICATION

This application claims the benefit of U.S. Provisional Patent Application No. 63/081,458, filed Sep. 22, 2020, the contents of which are herein incorporated by reference.

### BACKGROUND OF THE INVENTION

### Field of the Invention

The present invention relates to a portable and foldable cat litter box. More specifically, this device allows one to take their beloved pet on a number of trips and to various locations while ensuring the pet has a designated area to relieve themselves.

### Description of the Related Art

Within the concurrent art, there are several litter boxes that exist for use by small animals, for example, which may include a tray having a shallow upstanding peripheral wall adapted to receive a newspaper or other material capable of absorbing moisture with supporting walls.

Another exemplary device in the field may include a housing that has a front wall and a door, a rear wall, a pair of side walls each with a window, a bottom wall with a bottom recess with a lower hinged door with plurality of ventilation apertures, a water bottle, and food receptible and the housing receives animal litter on the bottom wall.

Another device illustrates a kitty box provided for use in the home, camper or van wherein the kitty box allows pets to perform excretory functions inside during times of confinement.

Another device illustrates a system with a base container having a perimeter wall protruding substantially upward from a perimeter of a bottom panel with a lid configured to attach to the base to the container when the system is collapsed.

Another device illustrates a combination litter box and carrying case for small animal pets which is in the form of a generally enclosed housing having a front wall provided with an opening dimensioned to permit passage of the animal therethrough. The opening in the front wall permits the animal to move freely between the housing, which serves an externally mounted litter box, and the dwelling.

Another device illustrates a portable toilet for an animal, including a catchment part, and a collection part, wherein the catchment part is arranged over the collection part and is shaped to channel urine into the collection part.

Theses portable toilets/litter boxes are cumbersome to transport as many of them cannot be folded together. More importantly, they are not odor proof as many of them do not include a zipperable cover on top of the litter box.

### SUMMARY OF THE INVENTION

Provided in one aspect is a new travel litter box that is foldable, easy to transport and clean, and odor proof. The present invention relates to a device useful in the care of household pets, such as cats, to aid in neat disposal of bodily waste material while traveling. As such, it is easy to clean and folds into a small package as to allow for easy traveling and storage.

In one embodiment, it comprises one large rectangularly shaped box wherein there are four low walls lined with material for easy cleaning; a zipper surrounding the top of the device as to unzip and rezip the lid of the device, wherein the zippered top cover prevents spills during transportation once in use and locks in odor. On top of the lid of the device is an extra top pocket for a litter scoop and extra litter.

In another embodiment, there is also a snap closure around the outside of the device as to allow the device to be folded into a small package and a side handle for easy carrying.

This device is unique as it is a compact and efficient device to allow for a cat or other small animal to relieve themselves while traveling in a clean and designated area that prevents spills and odors.

There has thus been outlined, rather broadly, the more important features of a portable litter box, in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the device in detail, it is to be understood that the device is not limited in its application to the details of construction and to the arrangements of the components set forth in the following description, and/or illustrated in the drawings. The system is capable of other embodiments and of being practiced and carried out in various ways. Also, it is to be understood that the phraseology and terminology employed herein are for the purpose of description and should not be regarded as limiting.

These together with other objects of the device, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present device in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

Advantages of the present device will be apparent from the following brief description of exemplary embodiments thereof; which description should be considered in conjunction with the accompanying drawings. Having thus described the invention in general terms, reference will now be made to the accompanying drawings, which are not necessarily drawn to scale.

FIG. 1 illustrates a front perspective view of one embodiment of the litter box wherein the upper portion is in the closed position and zippered tight.

FIG. 2 illustrates a front right perspective view of the litter box unzipped and unfolded with a side handle, wherein the device is shown to be large enough to accommodate house cats.

FIG. 3 illustrates a top perspective view of the litter box wherein it is unzipped and filled with cat litter and is occupied by a cat at rest inside the device.

FIG. 4 illustrates a front view of the litter box unzippered and in the functional mode for leisure activities.

FIG. 5 illustrates a top plan view of the litter box zippered and folded together.

FIG. 6 illustrates a front view of the litter box zippered and folded with a retaining fastening safety.

FIG. 7 illustrates a front right perspective view of the litter box zippered and folded.

### DETAILED DESCRIPTION OF THE SEVERAL EMBODIMENTS

The detailed description set forth below is intended as a description of presently preferred embodiments of the system and does not represent the only forms in which the present system may be construed and/or utilized. The description sets forth the functions and the sequence of the steps for producing the system and accompanying apparatus. However, it is to be understood that the same or equivalent functions and sequences may be accomplished by different embodiments and also intended to be encompassed within the scope of the system.

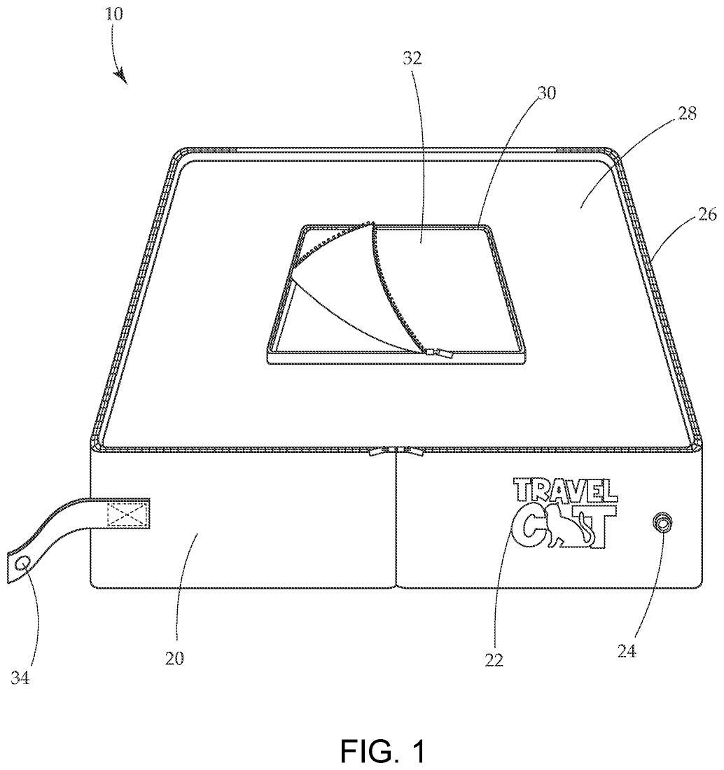

FIG. 1 illustrates a preferred embodiment of a portable litter box 10 wherein the main body 20 of the litter box 20 displays a “Travel Cat” logo 22 on the front of the device with a snap closure 24 located adjacent to the logo. The device 10 is foldable and may be snapped together using the snap closure 24 and a strap 34 to allow for ease of travel. Both the snap closure 24 and the strap 34 are preferably attached on the exterior of the main body 20. The rectangular main body 20 is constructed of a durable, lined fabric. In addition, the present device 10 also comprises a zipper 26 surrounding a top portion 28. The top portion 28 is secured to the main body 20 by a zipper 26.

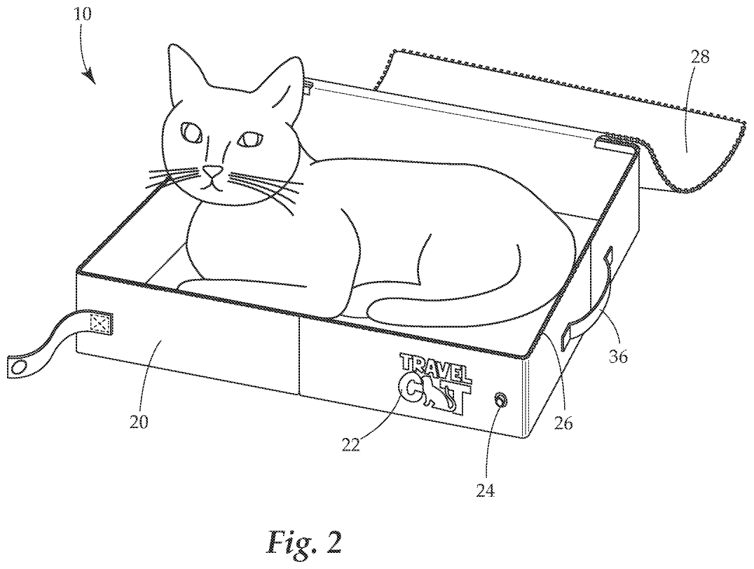

FIG. 2 illustrates the litter box 10 wherein the body 20 of the litter box 10 is unfolded as to display the “Travel Cat” logo 22, and snap closure 24, on the front of the device wherein the top portion 28 is unzippered in an open position and folded back. The strap 34 to secure the device is hanging by the side of the device.

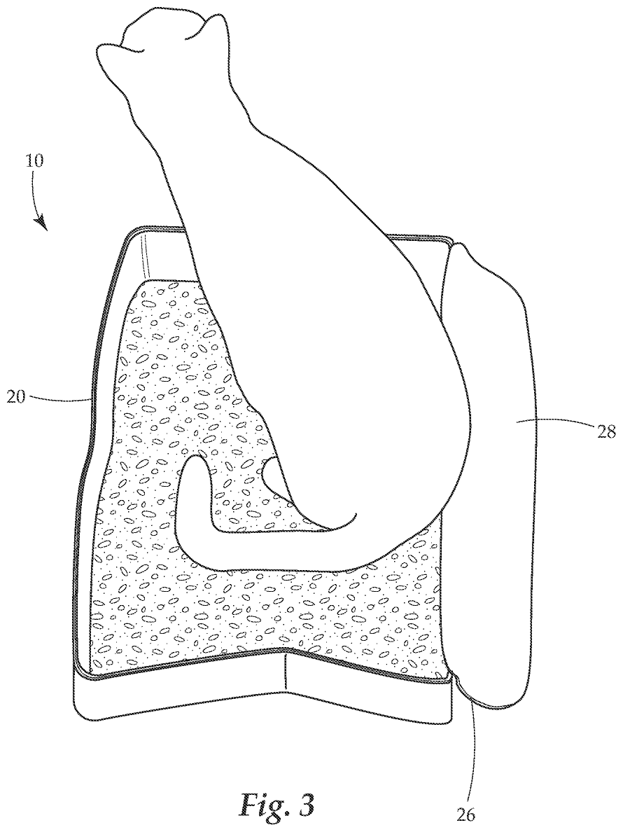

FIG. 3 illustrates the litterbox 10 in an unzippered position with the top portion 28 folded back, wherein a cat is sitting comfortably within the main body 20 of the device 10.

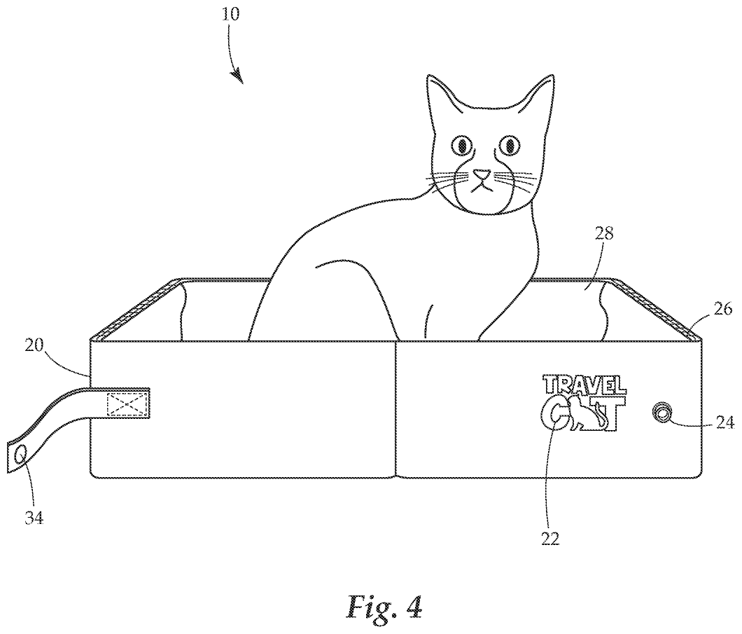

FIG. 4 illustrates a front view of the device 10 with a cat sitting comfortably within the main body 20. In some embodiments of the device 10, the main body 20 is big enough to accommodate large cats.

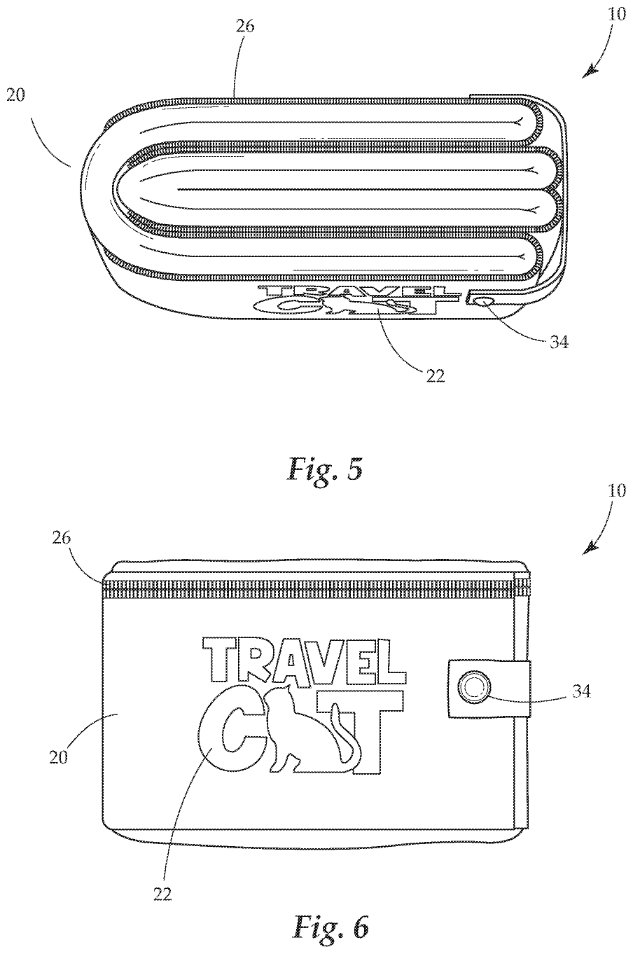

FIG. 5 illustrates the litter box 10 wherein the main body 20 of the of the litter box is folded with the “Travel Cat” logo 22 displayed on the outside of the device. In this embodiment, the zipper 26 is shut, and the litter box is secured by the strap 34 and the snap closure 24. In another embodiment, the present device 10 is secured by Velcro straps. In yet another embodiment, the main body 20 of the present device 10 is durable yet flexible to allow for easy manipulation when folded so that the entire device is very compact in its folded position.

FIG. 6 illustrates the present device 10 wherein the body of the device 20 is folded with the “Travel Cat” logo 22 displayed on the outside of the device, zipper 26 closed, and secured by the strap 34 with the snap closure 24.

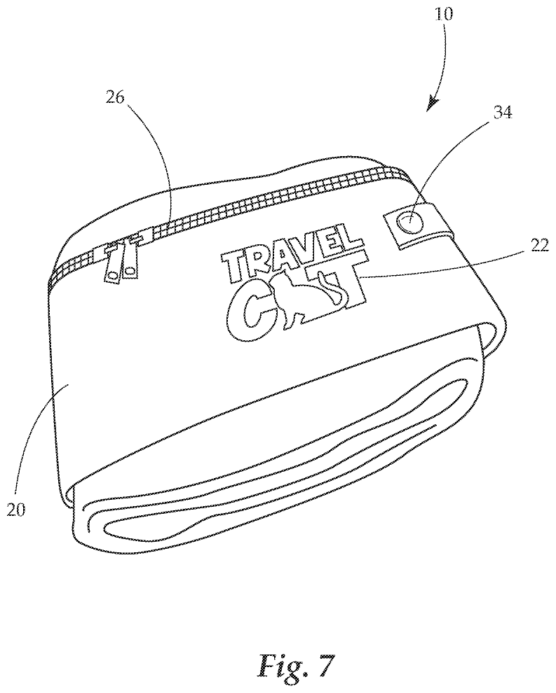

FIG. 7 illustrates the present device 10 wherein the body of the device 20 is folded with the “Travel Cat” logo 22 displayed on the outside of the device, zipper 26 closed, and secured by the strap 34 with the snap closure 24, as to show how compact it is.

As shown herein, a new portable litter box that is foldable, easy to transport, and odor proof is disclosed by utilizing a zipper mechanism and a folding mechanism.

1. A portable and foldable waste sanitation device for pets comprising:
a foldable main body;
a top portion; and
a zipper;
wherein the top portion is pivotably attached to a back of the foldable main body; and
wherein the top portion is secured to the foldable main body via the zipper.

2. The portable and foldable waste sanitation device of claim 1, wherein the foldable main body further comprises a strap with a fastening device disposed on an exterior of the foldable main body.

3. The portable and foldable waste sanitation device of claim 1, wherein the top portion further comprises at least one zippered storage pocket.

4. The portable and foldable waste sanitation device of claim 2, wherein the foldable main body further comprises at least one handle disposed on an exterior of the foldable main body.
